(19) United States
(12) Patent Application Publication
(10) Pub. No.: US 2005/0023362 A1
(43) Pub. Date: Feb. 3, 2005

(54) Method and apparatus for controlling humidity with a heater unit and a cooler unit

(75) Inventor: Paul C. Wacker, Plymouth, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/632,788

(22) Filed: Aug. 1, 2003

(51) Int. Cl. B01F 3/02; G05D 21/00

(52) U.S. Cl. 236/44 R

(57) ABSTRACT

Methods and apparatus for controlling an HVAC system to more readily meet both the sensible (i.e. temperature) and latent (i.e. moisture removal) cooling loads of an inside space. Briefly, and in one illustrative embodiment, a cooling unit is activated to satisfy the sensible cooling demands of the inside space, and if after the sensible cooling demands have been satisfied, and it is determined that the latent cooling demands have not yet been met, both a cooling unit and a heating unit are activated to help provide additional latent cooling to the inside space. Both the cooling unit and the heating unit may be activated to help minimize the sensible cooling provided to the inside space during the drying cycle.

### FIELD

The present invention is related to the field of heating, ventilation and air conditioning (HVAC), and more particularly, to methods and apparatus for controlling the humidity of an inside space by activating both a heating and a cooling unit under selected conditions.

### BACKGROUND

The level of comfort in an inside space is related to both temperature and humidity. While temperature control has long been a primary focus of many HVAC systems, humidity control is becoming ever more important. When an air conditioner is operating at steady state, the air conditioner coils are sufficiently cool to cause water condensation, thus removing water from the air and reducing the humidity of the air and the inside space.

Under some circumstances, the air conditioner may provide adequate temperature cooling (i.e. sensible cooling) but inadequate moisture removal (i.e. latent cooling). This can occur when, for example, the cooling capacity of the air conditioner is large relative to the cooling load of the inside space. In some cases, the air conditioner is simply oversized for the inside space, and in other cases, the environmental conditions only present a limited cooling load to the air conditioner. In these and other cases, the air conditioner may only run for relatively short periods of time while satisfying the sensible (i.e. temperature) cooling load of the inside space. However, and particularly when there is significant humidity in the inside space, the relatively short run times of the air conditioner may fail to satisfy the desired latent (i.e. moisture removal) cooling load of the inside space.

### SUMMARY

The present invention is directed towards methods and apparatus for controlling an HVAC system to more readily meet both the sensible (i.e. temperature) and latent (i.e. moisture removal) cooling loads of an inside space. Briefly, and in one illustrative embodiment, this may be accomplished by activating a cooling unit cycle to satisfy the sensible cooling demands of the inside space, and if after the sensible cooling demands have been met the latent cooling demands have not yet been met, activating a drying cycle to provide further latent cooling to the inside space. During the drying cycle, one illustrative embodiment activates both the cooling unit and a re-heating unit to help provide additional latent cooling to the inside space. Both the cooling unit and the heating unit may be activated to help minimize the sensible cooling provided to the inside space during the drying cycle.

As is conventional in many HVAC systems, the cooling unit and the heating unit are sized to cool and heat the inside space, respectively, under expected worst case conditions, and operate in either a relatively constant “on” state or an “off” state, as desired. When so provided, the cooling unit and the heating unit may not be precisely matched in output capacity, and thus when both are activated, the sensible cooling/heating of the inside space may be effected at least to some degree. However, because the control is relatively simple, and little or no additional hardware may be required, the present invention may provide a cost effective way to help control both sensible and latent cooling of an inside space. Furthermore, the present invention may be used to help control both sensible and latent cooling in many existing HVAC systems, with little additional cost.

### BRIEF DESCRIPTION OF THE DRAWINGS

FIG. 1 is a highly diagrammatic schematic view of an HVAC system adapted to control an inside space of a building or other structure;

FIG. 2 is a graph showing illustrative temperature and humidity conditions and a corresponding air conditioner cycle in accordance with the prior art;

FIG. 3 is a highly diagrammatic schematic view of an illustrative forced air HVAC system in accordance with the present invention;

FIG. 4 is a graph showing how an illustrative embodiment of the present invention uses both cooling and heating to help control the humidity in an inside space; and

FIG. 5 is a graph showing how another illustrative embodiment of the present invention uses both cooling and heating to help control the humidity in an inside space, where the HVAC system includes a cooling unit with multiple cooling stages.

### DETAILED DESCRIPTION

The following detailed description should be read with reference to the drawings. The drawings, which are not necessarily to scale, depict illustrative embodiments and are not intended to limit the scope of the invention.

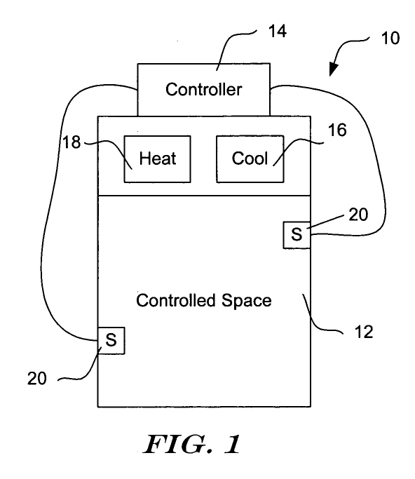

FIG. 1 is a highly diagrammatic schematic view of an HVAC system 10 adapted to control an inside space 12 of a building or other structure. The HVAC system 10 includes a controller 14, a cooling unit 16 and a heating unit 18. The controller 14 receives information about conditions in the inside space 12 from one or more sensors 20. The sensors 20 may include temperature sensors, humidity sensors, or any other suitable sensors, as desired. The cooling unit 16 and the heating unit 18 may each be adapted or sized to have sufficient capacity to provide cooling and heating under expected worst case cooling and heating conditions, respectively, for the inside space 12. In some embodiments, the cooling unit 16 and the heating unit 18 may operate in either a relatively constant “on” state or an “off” state, as desired. A relatively constant “on” state means that the cooling unit 16 and the heating unit 18 may provide a relatively constant output when activated, which is not modulated or dependent on, for example, the output temperature of the air provided by the HVAC system to the inside space 12. One illustrative example is a constant volume rooftop HVAC system, commonly used on commercial buildings. Other examples include residential HVAC systems, or any other suitable HVAC system. In addition, the heating and/or cooling unit may include multiple stages, if desired.

The controller 14 may be configured to monitor conditions in the inside space 12 using information from the sensors 20, and may control the cooling unit 16 and the heating unit 18 accordingly. For example, if the temperature in the space is above a cooling set point temperature, the controller 14 may activate the cooling unit 16 to lower the temperature in the inside space 12. While cooling and/or heating may be produced by the use of radiant or sub-floor heating, for example, in a preferred embodiment, the HVAC system 10 provides cooling and/or heating via a forced air HVAC system.

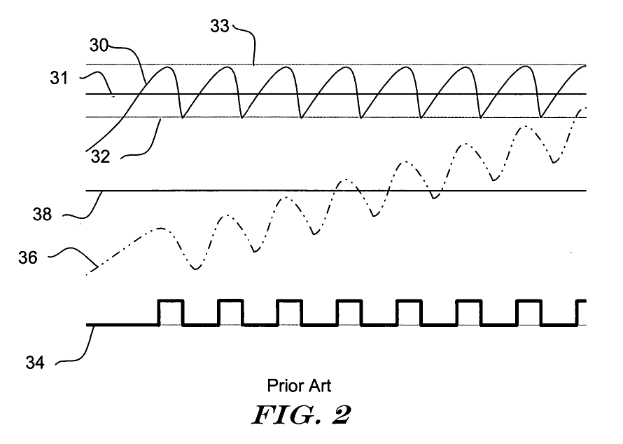

FIG. 2 is a graph showing illustrative temperature and humidity conditions along with a number of corresponding air conditioner cycles in accordance with the prior art. The primary focus of many prior art air conditioner systems is to control only the temperature of an inside space, illustrated as temperature curve 30. The temperature curve 30 is kept within a degree or two of a cooling temperature set point 31. As can be seen, the temperature curve 30 tends to oscillate around the cooling temperature set point 31 between a lower minimum 32 and an upper maximum 33. When the temperature curve 30 reaches the upper maximum, the air conditioner is typically turned on, as shown by the corresponding pulse on the air conditioner cooling cycle curve 34.

One limitation of such a system is that there is only an indirect reduction of the humidity 36 in the inside space. As can be seen, when the air conditioner is on, the humidity may drop, as illustrated by humidity curve 36. However, when the air conditioner has a relatively short duty cycle because of a relatively light sensible load, and/or when there are relatively humid conditions, the humidity 36 in the inside space may still rise over time. Eventually the humidity 36 may become sufficiently high that, even at the desired cooling set point temperature 31, conditions in the inside space may become uncomfortable to the occupants. Also, high humidity 36 may increase the likelihood of unhealthy mold growth in the inside space, and may accelerate deterioration of carpet, furniture, drywall, etc.

In one illustrative embodiment of the present invention, the humidity of an inside space is monitored until it rises above a predetermined humidity threshold. Once this occurs, and during periods when the cooling unit is not used to satisfy the sensible cooling demands of the inside space, both the heating unit and the cooling unit are activated in their relatively constant “on” states.

The cooling unit and the heating unit are preferably sized to cool and heat the inside space, respectively, under expected worst case conditions, and operate in either a relatively constant “on” state or an “off” state, as desired. When so provided, the cooling unit and the heating unit may not be precisely matched in output capacity, and thus when both are activated, the sensible cooling/heating of the inside space may be effected at least to some degree. However, because the control is relatively simple, and little or no additional hardware may be required, the present invention may provide a cost effective way to control both sensible and latent cooling of an inside space. Furthermore, the present invention may be used to control both sensible and latent cooling in many existing HVAC systems, with little additional cost.

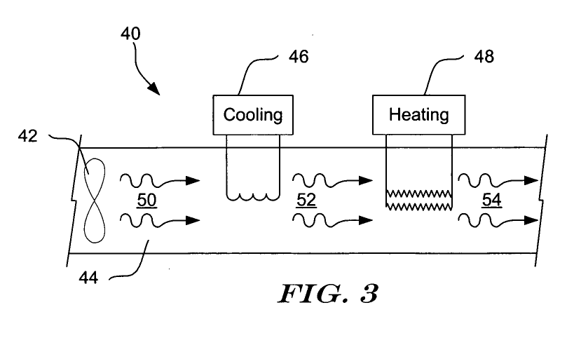

One illustrative forced air HVAC system is shown in FIG. 3. The HVAC system 40 of FIG. 3 includes a fan 42, ventilation ducts 44, a cooling unit 46 and a heating unit 48. It is contemplated that the heating and/or cooling unit may have one or more stages, as desired. In the illustrative embodiment, the cooling unit 46 is shown with coils and the heating unit 48 is shown with resistive heating elements. However, it is contemplated that any suitable type of cooling unit 46 or heating unit 48 may be used, as desired.

When the cooling unit 46 and the heating unit 48 are both activated, the fan 42 pushes incoming air 50 over the coils of the cooling unit 46. The cold air 52 leaving the coils of the cooling unit 46 will be cooler and in many cases drier than the incoming air 50. The fan pushes the cold air 52 past the heating unit 48, which then reheats the air. The warmed air 54 leaving the heating unit will be warmer than the cold air 52, but should have the same absolute humidity as the cold air 52 (though lower relative humidity). Whether the warmed air 54 is warmer or cooler than the incoming air 50 is a function of the relative capacities of the cooling unit 46 and the heating unit 48. The relative locations of the fan 42, the cooling unit 46, and the heating unit 48 may be changed, as desired, depending on the application.

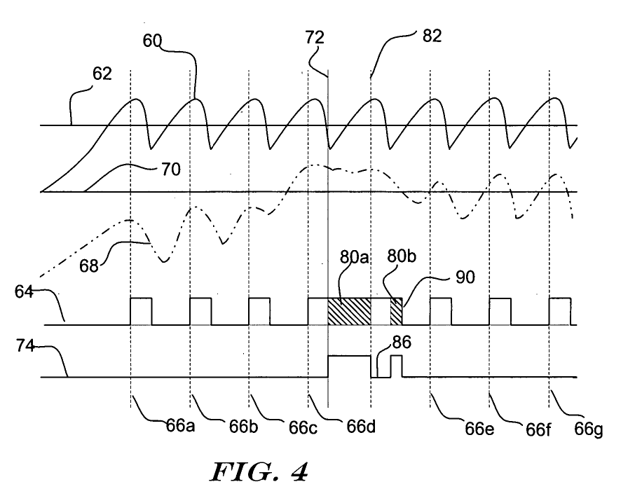

FIG. 4 is an illustrative graph showing the use of both a cooling unit and a heating unit to help control the humidity in an inside space. The temperature 60 of the inside space is shown oscillating about a cooling temperature set point 62. The activation/deactivation of the cooling unit to control the temperature 60 and in some cases the humidity in the inside space is shown by cooling cycle curve 64. The activation times for each cycle of the cooling unit are shown by dashed lines 66a-66h. As can be seen, the activation times 66a-66h for the cooling unit correspond to a cooling unit activation temperature, which is typically one or two degrees above the cooling temperature set point 62. In addition, the cooling cycle of the cooling unit typically is sufficiently long such that temperature 60 of the inside space is driven below the cooling temperature set point 62 by one or two degrees, thus creating a degree of hysteresis in the system.

In the illustrative embodiment, the humidity 68 in the inside space is monitored and, once the humidity 68 exceeds a predetermined humidity threshold 70, the humidity 68 begins to be actively controlled. In one embodiment, if the temperature 60 is at or below the temperature set point 62, and the humidity 68 is above the predetermined humidity threshold 70, both the cooling unit and the heating unit are activated. This is shown by cooling cycle curve 64 and heating cycle curve 74, and may be considered a “drying” mode. The times at which the “drying” mode is activated are indicated in cross-hatch regions 80a and 80b of FIG. 4.

In the illustrative embodiment, the “drying” mode is used to provide additional latent cooling (i.e. moisture removal), while only having an incidental effect on the sensible cooling (i.e. temperature reduction) of the inside space. Because the cooling unit and the heating unit may not have output capacities that are precisely matched, some sensible heating/cooling may occur during each “drying” mode. However, such sensible heating/cooling is only incidental, and is a function of the HVAC equipment used to control the inside space.

In the illustrative embodiment, the “drying” mode is preferably not entered when the cooling unit is activated to satisfy the sensible cooling demands of the inside space. For example, at time 82, the temperature 60 in the inside space rises to a point where a normal cooling cycle would be activated by the controller of the HVAC system. Since some latent cooling takes place during such a normal sensible cooling cycle, and the heating unit consumes extra energy, the heating unit is preferably turned off, as shown at 86. However, if after the sensible cooling demands are satisfied, and the humidity 68 of the inside space is not reduced below the predetermined humidity threshold 70, the “drying” mode may be reentered, as shown at 80b, with the cooling unit and the heating unit once again both activated. Once the humidity 68 is brought below the predetermined humidity threshold 70, the “drying” mode may be exited, as shown at 90. As shown in FIG. 4, and in the illustrative diagram, the cooling unit may be held “on” from time 66d to time 90, and the heating unit may be cycled on during the “drying” modes 80a and 80b, as shown.

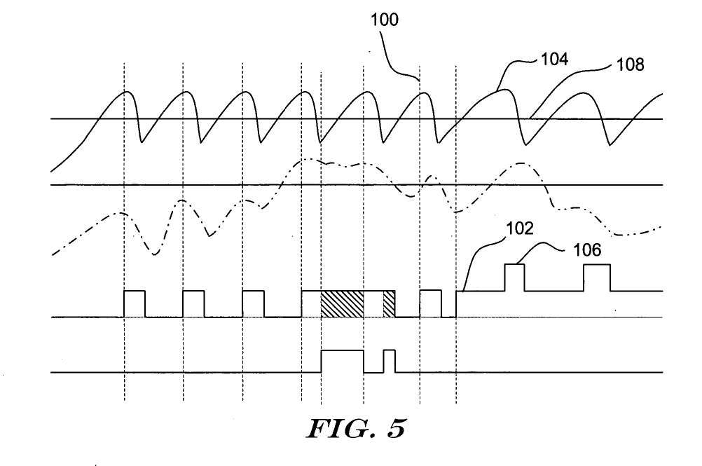

FIG. 5 is a graph showing another illustrative embodiment of the present invention, where the HVAC system has multiple cooling stages. When only a single cooling stage is needed to satisfy a call for cooling, the HVAC system may operate similar to that described above with respect to FIG. 4. That is, the graph shown in FIG. 5 is the same as the graph shown in FIG. 5 up to time line 100. However, after time line 100, the thermal load on the cooling unit has been increased, and the system first responds by activating a first cooling stage of the cooling unit, as shown at 102. Because of the increased thermal load, however, the first cooling stage of the cooling unit cannot satisfy the sensible cooling demands of the inside space. For example, when the first cooling stage is activated, the temperature curve 104 of FIG. 5 does not significantly drop. As such, and after a period of time, a second cooling stage is also activated, as shown at 106. With both the first and second cooling stages activated, the temperature drops below the temperature set point 108. After the temperature 104 drops below the temperature set point 108, the second cooling stage is deactivated, but the first cooling stage remains on in the illustrative diagram. The second stage may continue to be activated as need to until the thermal load of the inside space decreases sufficiently such that both the first and second cooling stages of the cooling unit can be deactivated. In the illustrative embodiment, the heating unit is not activated when any of the cooling stages are active and satisfying the sensible cooling demands of the inside space. Thus, even when the second cooling stage is turned off, but the first cooling stage remains active, the heating unit is not activated. However, this is not required in all embodiments.

Those skilled in the art will recognize that the present invention may be manifested in a variety of forms other than the specific embodiments described and contemplated herein. Accordingly, departures in form and detail may be made without departing from the scope and spirit of the present invention as described in the appended claims.

1. A method of controlling an HVAC system having a heating unit and a cooling unit, the heating unit and the cooling unit configured to selectively operate in a relatively constant “on” state or an “off” state; the method comprising:
determining whether the humidity in an inside space is above a predetermined humidity threshold, and if so, operating both the heating unit and the cooling unit in their relatively constant “on” states.

2. The method of claim 1 wherein the step of operating both the heating unit and the cooling unit in their relatively constant “on” states is only performed if the temperature in the inside space is below a predetermined cooling set point.

3. The method of claim 2 wherein only the cooling unit is operated if the temperature in the inside space is above the predetermined cooling set point, regardless of the humidity in the inside space.

4. The method of claim 1 wherein the cooling unit includes two or more cooling stages, the method further comprising the steps of:
not operating both the heating unit and the cooling unit in their relatively constant “on” states if two or more cooling stages of the cooling unit are activated.

5. A method of controlling an HVAC system having a heating unit and a cooling unit, the heating unit and the cooling unit configured to selectively operate in a relatively constant “on” state or an “off” state, the method comprising:
operating the cooling unit to satisfy a call for cooling for the inside space; and
after the call for cooling has been satisfied, determining if the latent cooling demands have been met, and if not, operating both the heating unit and the cooling unit in their relatively constant “on” states.

6. A method according to claim 5, further comprising the steps of:
deactivating the heating unit and the cooling unit once the latent cooling demands have been satisfied.

7. A method according to claim 5, further comprising the steps of:
deactivating the heating unit while maintaining the cooling unit if a subsequent call for cooling is provided.

8. A method according to claim 5, further comprising the steps of:
deactivating the heating unit and the cooling unit of the latent cooling demand has been satisfied and there is no current call for cooling; and
deactivating the heating unit while maintaining the cooling unit if the latent cooling demand has not yet been satisfied but a subsequent call for cooling is provided.

9. A method of controlling an HVAC system having a heating unit and a cooling unit, wherein the heating unit and the cooling unit are configured to selectively operate in a relatively constant “on” state or an “off” state, the HVAC system configured to have a cooling set point temperature, the method comprising:
determining a temperature at a location within an inside space;
determining a humidity at a location within the inside space;
selecting a mode in which to operate the HVAC system from among the following operating modes depending on the determined temperature and/or humidity:
selecting an “off” mode if the humidity is below a predetermined humidity threshold and the temperature is below a temperature that is related to the cooling set point temperature, the “off” mode having the heating unit and the cooling unit both in their “off” states;
selecting a “cooling” mode if the temperature is above a temperature that is related to the cooling set point temperature, the “cooling” mode having the heating unit in its “off” state and the cooling unit in its relatively constant “on” state; and
selecting a “drying” mode if the humidity is above the predetermined humidity threshold and the temperature is below a temperature that is related to the cooling set point temperature, the “drying” mode having the heating unit and the cooling unit both in their relatively constant “on” states.

10. The method of claim 9 wherein the cooling unit includes a first cooling stage and a second cooling stage, the method further comprising the steps of:
predicting or determining whether the first stage of the cooling unit can provide adequate sensible cooling to the inside space; and
selecting the “off” mode if the humidity is below the predetermined humidity threshold and the temperature is below a temperature that is related to the cooling set point temperature;
selecting the “cooling” mode and activating only the first stage of the cooling unit if the humidity is below the predetermined humidity threshold and the temperature is above the temperature that is related to the cooling set point, and the predicting or determining step predicts or determines that the first stage can provide adequate sensible cooling for the inside space;
selecting the “cooling” mode and activating both the first stage and second stage of the cooling unit if the humidity is below the predetermined humidity threshold and the temperature is above the temperature that is related to the cooling set point, and the predicting or determining step predicts or determines that the first stage cannot provide adequate sensible cooling for the inside space;
selecting the “drying” mode and activating only the first stage of the cooling unit if the humidity is above the predetermined humidity threshold and the temperature is above the temperature that is related to the cooling set point.

11. The method of claim 10 further comprising the step of:
selecting the “cooling” mode and activating both the first stage and the second stage of the cooling unit if the humidity is above the predetermined humidity threshold and the temperature is above the temperature that is related to the cooling set point, and the predicting or determining step predicts or determines that the first stage cannot provide adequate sensible cooling for the inside space.

12. In an HVAC system having a heating unit sized to heat an inside space under an expected heating load and a cooling unit sized to cool the inside space under an expected cooling load, the improvement comprising:
a controller adapted to determine whether the space is above a predetermined humidity threshold; and if so, operating both the heating unit and the cooling unit.

13. An HVAC system according to claim 12, wherein the controller is further adapted to determine if the temperature of the inside space is above a predetermined temperature, and if so, activating the cooling unit and not the heating unit, regardless of the humidity in the inside space.

14. An HVAC system according to claim 12, wherein the controller is adapted to operate both the heating unit and the cooling unit only if the temperature in the inside space is below a predetermined cooling set point.

15. An HVAC system according to claim 14, wherein the controller is adapted to operate the cooling unit and not the heating unit if the temperature in the inside space is above a predetermined cooling set point.

16. A method of updating an HVAC system having a heating unit sized to heat an inside space under an expected heating load, a cooling unit sized to cool the inside space under an expected cooling load, and a controller, the method comprising:
updating the controller to determining whether the humidity in the inside space is above a predetermined humidity level; and if so, operating both the heating unit and the cooling unit.

17. A method according to claim 16, wherein the updating step further updates the controller to determine whether the temperature of the inside space is above a predetermined temperature, and if so, only activating the cooling unit and not the heating unit, regardless of the humidity in the inside space.

18. A method according to claim 16, wherein the updating step further updates the controller to operate both the heating unit and the cooling unit only if the temperature in the inside space is below a predetermined cooling set point.

19. A computer-readable medium having stored thereon a computer program for controlling an HVAC system that services an inside space which, when executed by a controller, is capable of performing the following steps:
determining whether the humidity in the space is above a predetermined humidity level, and if so, activating both a heating unit and a cooling unit of the HVAC system.

20. A computer-readable medium according to claim 19, wherein the computer program when executed by the controller, is also capable of performing the follow step:
determine if the temperature of the inside space is above a predetermined temperature, and if so, activating only the cooling unit and not the heating unit.

21. A method of controlling an HVAC system having a heating unit sized to heat an inside space under an expected heating load and a cooling unit sized to cool the inside space under an expected cooling load, the heating unit and cooling unit configured to selectively operate in a relatively constant “on” state or an “off” state, the method comprising:
determining whether the humidity in an inside space is above a predetermined humidity threshold, and if so, operating both the heating unit and the cooling unit in their relatively constant “on” states.

22. A method of controlling an HVAC system having a heating unit sized to heat an inside space under an expected heating load and a cooling unit sized to cool the inside space under an expected cooling load, the method comprising:
determining whether the humidity in an inside space is above a predetermined humidity threshold, and if so, operating both the heating unit of the HVAC system and the cooling unit of the HVAC system.

23. A method of controlling an HVAC system having a heating unit and a cooling unit, the method comprising:
operating the cooling unit to satisfy a call for cooling for the inside space; and
after the call for cooling has been satisfied, determining if the latent cooling demands have been met, and if not, operating both the heating unit and the cooling unit.
